(19) United States
(12) Patent Application Publication
(10) Pub. No.: US 2011/0315785 A1
(43) Pub. Date: Dec. 29, 2011

(54) Mixing device for flowable materials

(76) Inventors: Alexander Essing, Ingolstadt (DE); Ingo Viehboeck, Idstein (DE); Herbert Buchberger, Adelschlag-Pietenfeld (DE)

(21) Appl. No.: 12/803,508

(22) Filed: Jun. 29, 2010

(51) Int. Cl. B05B 9/00

(52) U.S. Cl. 239/1; 239/142

(57) ABSTRACT

A device for mixing fluid, and powdered, flowable materials, particularly for mixing automotive refinish coatings for use with spray guns, having a first component (3) mounted rotatably on a frame (2), having a second component bearing or forming a mixing product receptacle (4) mounted rotatably on the first component (3) and having at least one drive device for a rotary drive of the first component (3) and a rotary drive of the mixing product receptacle (4), whereby the drive device is preferably designed in such a way that the direction of rotation of the first component (3) is opposed to the direction of rotation of the mixing product receptacle (4). According to the invention the ratio of rotation between the rotational speed of the first component (3) and the rotational speed of the mixing product receptacle (4) being approximately 1:1.1 to 1:2.0, preferably 1:1.3 to 1:1.8, whereby a preferable rotational speed of the first component (3) is approximately 200 to 400 r/min, preferably 250 to 350 r/min.

### FIELD OF THE INVENTION

The invention relates to a device for mixing liquid and powdered, flowable materials, particularly for mixing automotive refinish coatings for use with spray guns.

### BACKGROUND

A mixing device is disclosed in EP 1 293 245 B1 which has a first component shaped as a rotary arm that is mounted rotatably on a frame and exhibits a rotary axis. The rotary arm sits rotationally fixed on the shaft of a drive device, which can be integrated into the frame. A v-belt pulley is rotationally fixed on a surface of the frame in the opposite direction of the rotary arm. The v-belt pulley has a through-opening for the drive shaft and is concentric to the rotary axis of the shaft with an active surface supporting a radial wedge. An additional second component is a mixing cup for holding mixing products that is mounted rotatably on one side of the rotary arm. Said mixing product receptacle is inclined at an angle in relation to the longitudinal direction of extension of the rotary arm. An external peripheral region of said mixing product receptacle is toothed and is therefore integrally constructed into the mixing product receptacle as an integrated v-belt pulley. In addition to said v-belt pulleys, two axial deflection elements spaced apart from each other and identical with regard to their axis of symmetry are arranged on the side of the rotary arm around which the smooth side of the v-belt is led. Said v-belt is led on the side of the rotary arm over two radial deflection elements, also symmetrically mounted with regard to their axis of symmetry, to the v-belt pulley, which is integrally designed into the mixing product receptacle. The smooth side of the v-belt is also led in this case around the radial deflection elements. The rotary drive and the deflection device are designed in such a way that the rotary arm direction of rotation and the mixing product receptacle direction of rotation are aligned in opposite directions to each other.

The deflection device construction should enable a functionally reliable deflection of rotary motion even under a relatively heavy weight load on the second component (mixing product receptacle). This construction, however, is relatively expensive to produce overall due to the multitude of axial and radial deflection elements. Furthermore, such a construction is relatively susceptible to faults.

It is therefore an object of the present invention to provide a device for mixing liquid, flowable or powdered materials, particularly for mixing automotive refinish coatings for use with spray guns, which has a simple and therefore cost-effective construction and which can also be operated with higher functional reliability and extremely good mixing results.

This objective is accomplished with the characteristics of the invention described below.

### SUMMARY OF THE INVENTION

In one aspect, the invention is a device for mixing fluid, flowable or powdered materials, particularly for mixing automotive refinish coatings for use with spray guns includes a first component mounted rotatably on a frame as well as a second component bearing or forming a mixing product receptacle mounted rotatably on the first component. Furthermore, at least one drive device for the rotary drive of the first component and the rotary drive of the mixing product receptacle is provided, whereby the drive device is preferably designed in such a way that the direction of rotation of the first component is opposed to the direction of rotation of the mixing product receptacle. According to the invention and many tedious trials, it has been discovered that excellent mixing results are achieved, particularly for auto refinish coatings, with a ratio of rotation of approximately 1:1.1 to 1:2.0, preferably 1:1.3 to 1:1.8, between the rotational speed of the first component and the rotational speed of the mixing product receptacle, i.e. a 1.1-2.0 times faster rotational speed of the mixing product receptacle. This simultaneously prevents undesirable bubbling and ensures an excellent and equal distribution of the mixing paint, thereby resulting in excellent quality of finishing work using a spray gun. As the invention trials also showed, said excellent results are particularly achieved within a rotary speed range for the first component of approximately 200 to 400 rotations/min (r/min), preferably 250 to 350 r/min. This previously described ratio of rotation results in a desirable total flow in the mixing product. Higher rotational speeds produce results similar to a centrifuge and therefore cause separation where applicable. Lower rotational speeds on the other hand do not produce an effective flow that allows sufficient mixing as extensive invention trials have shown. Such a ratio of rotation achieves, therefore, an excellent mixing ratio, which additionally prevents excessive “sloshing” of the mixing product in the mixing product receptacle. This is advantageous because the container lid becomes only slightly wet and the filter usually arranged in the lid, particularly for automotive refinish coatings, does not become defiled by inhomogeneous mixing products.

A velocity distribution is particularly useful in connection with the previously described ratio of rotation, in that a triangular velocity profile is set across the diameter as a result of the velocity in the mixing product receptacle, by which the lowest and fastest mixing product velocities are each within the opposing mixing product ranges and namely in such a way that the fastest velocity is achieved in the mixing product receptacle area associated with the drive shaft of the first component. Such a velocity field also significantly contributes to preventing excessive sloshing of the mixing product in the mixing product receptacle. The previously described advantages are hereby achieved.

A compact construction according to an additional preferred embodiment also allows for the rotary drive shaft to bear a pulley in the remote shaft area of the mixing product receptacle around which a drive belt of the drive device is led. According to an embodiment preferred for this purpose, the drive belt is also led around a belt pulley that is fixed to the frame through which a drive shaft is fed to a drive motor, preferably a stepping motor, of the drive device and connected rotationally fixed to the first component, preferably a rotary arm. The result is a belt drive belt guide that is low in cost and less susceptible to failure with which the desired rotary motions can be reliably achieved. The use of a stepping motor to power the drive shaft is advantageous—in connection with the mixing task to be handled and particularly mixing tasks to be handled regarding automotive refinish coatings—because it is small and can therefore be easily integrated into a mixing device frame. An additional significant advantage of using said stepping motor is that it does not spark and therefore fulfills explosion protection directives, particularly within the scope of motor vehicle paint shops. Control of the stepping motor in a variable manner makes for an additional advantage, particularly with regard to its rotational speed, which can be started and stopped slowly so that undesirable sloshing of the mixing liquids, particularly paints, added to the mixing product receptacle can be reliably prevented. Otherwise, the stepping motor has a simple and inexpensive gearless motor.

According to an additional significant aspect of the invention that is independent of the ratio of rotation, whereby the combination of these invention variations represent the preferred embodiment, the mixing product receptacle is detachably mounted to one of these rotary drive shafts of the drive device. Such a detachable mounting device is preferably a mounting device detachable without the use of tools. In principal, however, a detachable mounting device that requires tools in order to be removed can also be utilized. Increased flexibility can be achieved by using such a detachable mounting device for the mixing product receptacle directly on the rotary drive shaft of the drive device on the mixing product receptacle because mixing product receptacles adapted from different container forms from various manufacturing firms, for example, can be easily, quickly and reliably replaced and removed, for example, from the first component designed as a rotary arm. Furthermore, such a detachable connection of the mixing product receptacle to the rotary drive shaft of the drive device is also especially advantageous for cleaning purposes because accessibility to the individual device components when the mixing product receptacle is removed is significantly better than in the case of a permanently attached mixing product receptacle.

Different manufacturers also use different container types for their coatings, a problem that particularly arises with automotive refinish coatings. These prefabricated coatings must be regularly fine adjusted to the desired/required coating color by making paint additions. A subsequent mixing of the paint composition is necessary in order to homogenize the fine mixture. This subsequent mixing is currently done by hand with a stirring stick, which can cause problems in that air bubbles are formed that in turn lead to poor quality when conducting spray operations with a spray gun. The solution proposed by the invention advantageously avoids mixing by hand, whereby different container types from different automotive paint manufacturers can be inserted into the mixer according to the invention because the detachable mixing product receptacle allows mixing product receptacles to be used, which are perfectly adjustable in each case to one or more container(s) from different paint manufacturers.

Due to the detachable and direct connection of the mixing product receptacle to the rotary drive shaft, the detachable connection can also be realized without additional component costs. In an embodiment of the invention that is particularly preferred, the detachable mounting device is a quick connect coupling detachable without tools. This quick connect coupling detachable without tools can be a lock and plug connection or bayonet connection for example.

According to a particularly preferred concrete embodiment of the present invention, which also represents a separate variation of the invention, the overall device is mounted in a protective housing or furnished with a protective housing in order to prevent access to the rotating device components, i.e. the rotary arm and the mixing product receptacle, particularly where they connect on the frame. Said protective housing is designed in such a way that the mixing product is fed, for example, with an automotive refinish coating container together with the container lid to the mixing product receptacle through an opening on the side of the housing. Particularly preferred in this case is the protective housing being designed in multiple parts in such a way that one protective housing part is rotatably connected with the first component so that said protective housing part is rotatable relative to at least an additional protective housing part. For example, said protective housing part rotates in order to form a protective cover. Such a protective housing part that also rotates avoids an otherwise necessary separate protective device. An embodiment is hereby particularly preferred in which the protective housing parts rotate relative to each other in the adjacent region and are mutually supported by each other and slideable in a contact connection or adjacent to each other with a defined gap, whereby the gap is so minimal that access to the housing interior, with fingers for example, is not possible.

Furthermore, according to an additional preferred concrete embodiment, mounting of a control and display device and/or an electrical power cable for a network connection is provided, particularly on a protective housing part that does not rotate. At least one mixing program, for example, can be selected using the control and display device and the mixing parameters, for example, rotational speed and/or mixing times can be preset. If applicable, the control and display device can be equipped with a documentation device with which mixing documentation can be generated and/or retrieved. The control and display device possesses a PC interface with which operator interventions are possible and/or documentable at any time, such as changes to mixing times or mixing programs.

According to an additional particularly preferred embodiment of the present invention, the mixing product receptacle has a receptacle contour that tapers conically from the receptacle opening downward in the direction of the receptacle floor. As an alternative or in addition, elastically pre-tensioned retaining element can be arranged in the mixing product receptacle (4), which attach to and hold in place under spring tension a container placed in the mixing product receptacle. Both of the previously described measures allow individual as well as combinations of different container types to be reliably held in a mixing product receptacle so that overall only a limited number of mixing product receptacles have to be held in readiness as a set of mixing product receptacles for example.

### DESCRIPTION OF THE DRAWINGS

The invention will be described in greater detail with the aid of the subsequent figures which are by way of illustration and not limitation.

In the drawings:

FIG. 1 is a schematic and perspective view of a mixing device according to the invention;

FIG. 2 is a detailed schematic and perspective view of a rotary arm together with detachable mixing product receptacle.

FIG. 3 is a schematic and perspective view in accordance with FIG. 2 with attached mixing product receptacle; and

FIG. 4 is a schematic of a velocity field in the mixing product receptacle according to the invention.

### DETAILED DESCRIPTION

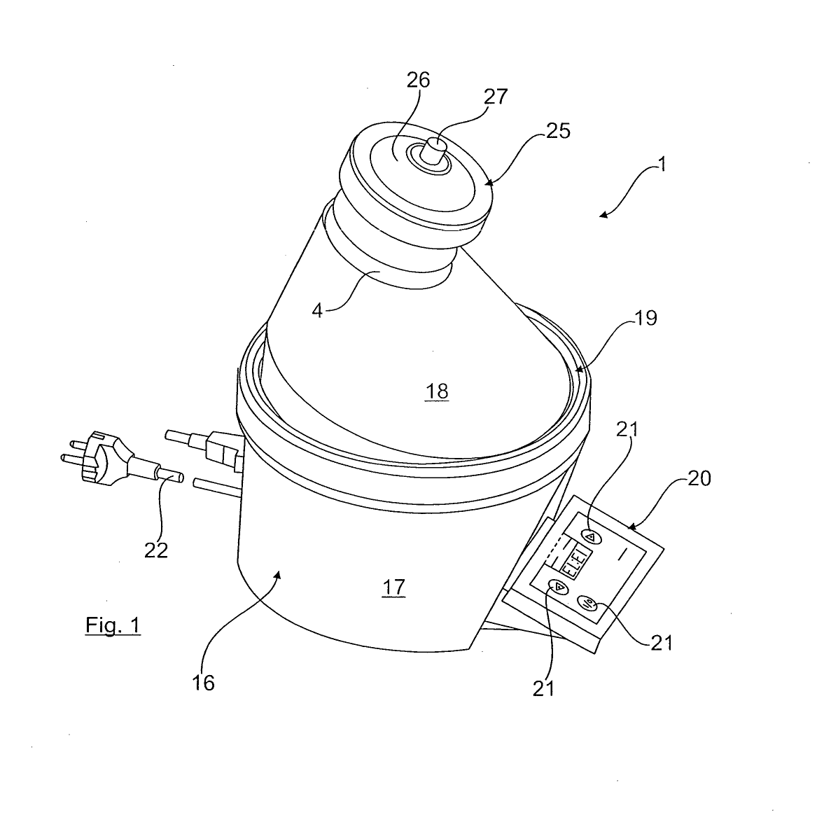

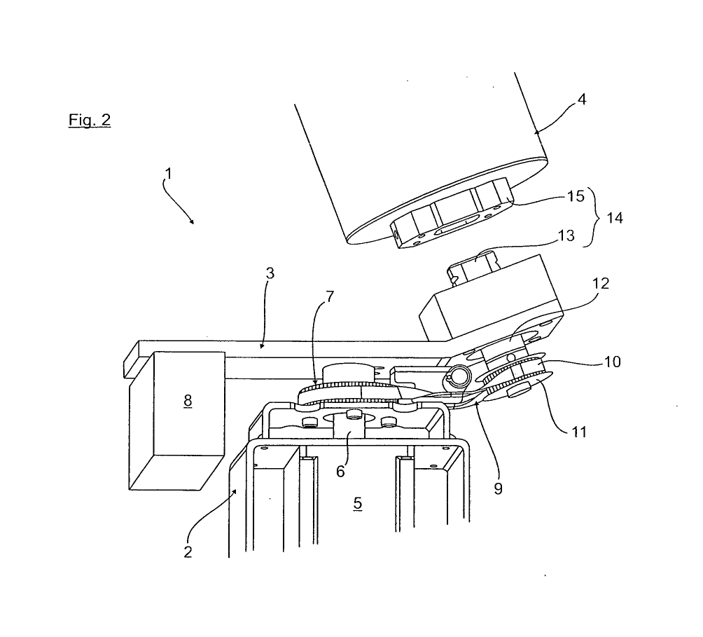

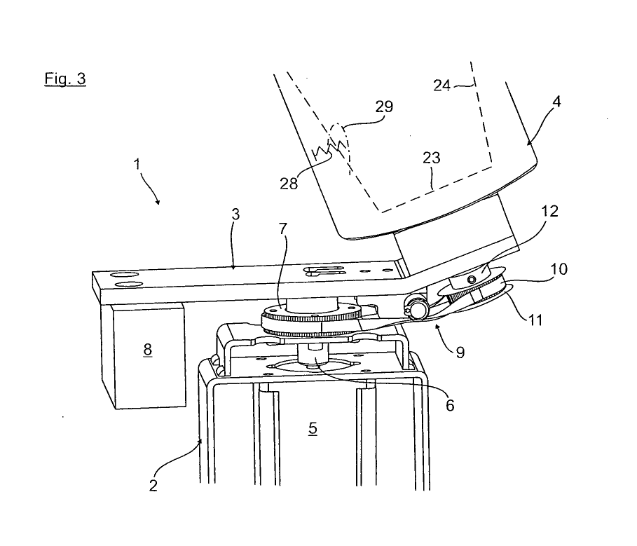

FIG. 1 shows a schematic and perspective view of a mixing device 1 which is a best mode of the invention, the inner workings of which are described in greater detail in connection with FIG. 2 and FIG. 3. Said mixing device has a frame 2 on which a rotary arm 3 is rotatably mounted, the nature of which is subsequently described in greater detail. A mixing product receptacle 4 is rotatably mounted on a first end of said rotary arm 3, the nature of which is also subsequently described in greater detail, whereby the mixing product receptacle 4 is displaced upward at a defined angle opposite the longitudinal axis of the rotary arm so that the mixing product receptacle 4 achieves an inclined angle. Schematically and as an example, a counter weight is arranged on the side of the rotary arm opposite the mixing product receptacle 4, which is advantageous as such for rotating processes and potentially occurring unbalances.

The rotary drive of the rotary arm 3 and the mixing product receptacle 4 is executed with a drive device that bears a stepping motor 5 (only shown here in blocks) whose drive shaft 6 is rotatably led through a toothed pulley 7 and connected rotationally fixed to the rotary arm 3.

The pulley 7 is a component of a v-belt pulley 9, which has a timing belt 10 as well as a second toothed pulley 11 around which the timing belt 10 is led. Furthermore, the v-belt pulley 9 also includes tension rollers, which maintain the tension of the timing belt 10 in order to ensure a functionally reliable power transmission.

As can be derived from FIG. 2, the pulley 11 is a component of a drive shaft 12 that is rotatably mounted on the rotary arm 3, which bears a plug-in lug 13 and is a component of a quick connect coupling 14 that forms the mounting device of a mixing product receptacle that is detachable without tools and, when the mixing product receptacle 4 is in the mounted position, is detachably connected with or snapped into the mixing product receptacle with a plug-in lug receptacle 15 on the side of the mixing product receptacle.

As particularly evident in FIG. 1, the assembly just described is mounted in a protective housing 16 of the mixing device 1, which merely consists of, for example, a lower stationary two-part protective housing component 17 and an upper, rotatable protective housing component 18 connected to the rotary arm 3, which rotates with the rotary arm 3 when a rotary movement occurs so that the protective housing component 18 is rotational relative to the protective housing component 17.

The adjacent area 19 of the protective housing components, which rotate relative to each other are designed here in such a way that a minimal gap exists between them so that access to the housing interior, with fingers for example, is not possible.

Furthermore, a control and display device 20 is arranged on the non-rotating protective housing component 17 with which a particular mixing program can be selected using operating buttons 21 (only schematically shown here) and by which a mixing product contained within the mixing product receptacle 4 is stirred depending on the rotation speed by way of a preset mixing characteristic. Furthermore, an outlet on the protective housing component 17, for example, is provisioned for an electrical power cable 22, which supplies power to the electrical components of the mixing device 1.

The inside design of the mixing product receptacle 4, as particularly shown in FIG. 3, is preferably conical, i.e. with a receptacle contour 24 that tapers conically from the receptacle opening downward in the direction of the receptacle floor 23 so that preferably a multitude of paint cups 25 containing automotive refinish coatings can be securely clamped into the mixing product receptacle. The paint cups 25 containing the automotive refinish coatings to be mixed are preferably outfitted with a lid 26 with a connection 27, which is inserted into a spray gun (not shown here) and with which the paint is drawn out of the paint cup 25.

As an alternative or in addition, a elastically pre-tensioned retaining element 29 with a spring 28, which lies on the paint container 25 when the paint container 25 is inserted and holds it in the mixing product receptacle 4 with a retention force can be provisioned in the mixing product receptacle 4 for holding paint containers as schematically shown in FIG. 3. In such a case, multiple retaining elements 29 distributed in the circumferential direction and in spaced relation to each other are preferred.

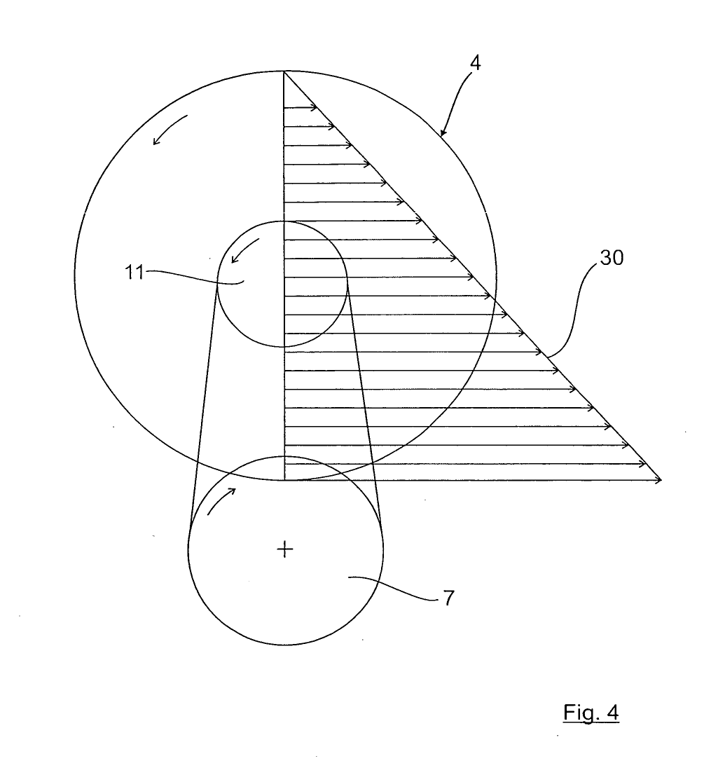

When the mixing device 1 previously described in detail and in examples is no longer operating, the rotary arm 3 and the mixing product receptacle 4 rotate in opposite directions as schematically shown in FIG. 4, whereby a resulting velocity field 30 is set in the case of a ratio of rotation between the rotational speed of the rotary arm 3 and the rotational speed of the mixing product receptacle 4 of approximately 1:1.5, for example at a rotational speed of 300 r/min, which is preset using the control and display device 20 as shown in FIG. 4. This triangular velocity field, which is set over the mean diameter of the mixing product receptacle 4 or the interior of the paint cup brings about an advantageous mixing of the respective paint in that the undesirable formation of air bubbles does not occur. Furthermore, such a velocity profile also prevents the undesirable sloshing of the paint onto the lid 26 and the filter (not shown here) arranged in the area of the lid, whereby it is easily and reliably ensured that the filter does not become defiled with an inhomogeneous, i.e. unmixed mixing product.

With such a mixing device and mixing method according to the invention, an especially high quality paint mixture is achieved, particularly for automotive refinish coatings, by which paint additions can be added to a base paint so that high quality can be achieved using a spray gun to apply the coating.

While a preferred embodiment of the invention has been described above, the present invention is not limited to the description but is limited only by the scope of the claims which follow:

We claim:

1. Device for mixing fluid, flowable or powdered materials, particularly for mixing automotive refinish coatings for use with spray guns comprising:
a) a first component (3) mounted rotatably on a frame (2);
b) a second component (3) bearing or forming a mixing product receptacle (4) mounted rotatably on the first component;
c) at least one drive device for the rotary drive of the first component (3) and the rotary drive of the mixing product receptacle (4), whereby the drive device is preferably designed in such a way that the direction of rotation of the first component (3) is opposed to the direction of rotation of the mixing product receptacle (4); and,
d) the ratio of rotation between the rotational speed of the first component (3) and the rotational speed of the mixing product receptacle (4) being approximately 1:1.1 to 1:2.0, preferably 1:1.3 to 1:1.8, whereby a preferable rotational speed of the first component (3) is approximately 200 to 400 R/min, preferably 250 to 350 R/min.

2. The device according to claim 1, having a triangular velocity profile (30) being set on the mixing product receptacle (4) with regard to the diameter of the mixing product receptacle.

3. The device according to claim 1, comprising the rotary drive shaft (12) bearing a mixing product receptacle pulley (11) in the remote shaft area of the mixing product receptacle (4) around which a drive belt (10) of the drive device is led.

4. The device according to claim 3, including the drive belt (10) being led further around a pulley (7) that is fixed to the frame through which a drive shaft (6) is rotatably fed to a drive motor, preferably a stepping motor (5), of the drive device and connected rotationally fixed with the first component, preferably a rotary arm (3).

5. The device according to claim 3, characterized by the pulleys (7, 11) being toothed and the drive belt being a timing belt (10).

6. The device, particularly according to claim 1, characterized by the mixing product receptacle (4) being detachably held to said rotary drive (12) of the drive device powering said receptacle.

7. The device according to claim 1, characterized by the detachable mounting device being formed by a quick connect coupling (14) detachable without tools, particularly a lock and plug connection or bayonet connection.

8. The device, particularly according to claim 1, characterized by the device (1) being mounted in a protective housing (16) over which the mixing product receptacle (4) is fed, preferably over an opening on the housing side and the protective housing (16) being designed in multiple parts in such a way that one protective housing part (18) is rotatably connected with the first component (3) so that this protective housing part (18) is rotatable relative to at least an additional protective housing part (17).

9. The device according to claim 8, characterized by the protective housing parts (17, 18), which rotate relative to each other in the adjacent region (19), being mutually supported by each other and slideable in a contact connection or adjacent to each other with a defined gap.

10. The device according to 8, characterized by a control and display device (20) bearing a PC interface and/or an electrical power cable (22) for a network connection being arranged on the protective housing (16), particularly on a protective housing part (17) that does not rotate with the rest of the device.

11. The device according to claim 10, characterized by at least one mixing program and/or mixing parameters, particularly the rotational speed and/or mixing times being preset or presettable/documentable using the control and display device (20).

12. The device according to claim 1, characterized by the mixing product receptacle (4) having a receptacle contour that tapers conically from the receptacle opening downward in the direction of the receptacle floor (23).

13. The device according to claim 1, characterized by at least one elastically pre-tensioned retaining element being arranged in the mixing product receptacle (4), which attaches to and holds in place under spring tension a container placed in the mixing product receptacle (4).

14. The method for operating a device according to claim 1.
